(19) United States
(12) Patent Application Publication
(10) Pub. No.: US 2017/0044471 A1
(43) Pub. Date: Feb. 16, 2017

(54) Sulfate-Free Liquid Laundry Detergent

(71) Applicant: The Sun Products Corporation, Wilton, CT (US)

(72) Inventors: Janet COOPE-EPSTEIN, Trumbull, CT (US); Adam GERMAIN, Naugatuck, CT (US); Lisa NAPOLITANO, Norwalk, CT (US); Cindy MOSER, Wilton, CT (US)

(73) Assignee: The Sun Products Corporation, Wilton, CT (US)

(21) Appl. No.: 15/236,110

(22) Filed: Aug. 12, 2016

Related U.S. Application Data
(60) Provisional application No. 62/205,333, filed on Aug. 14, 2015.

(51) Int. Cl. C11D 11/00; C11D 1/66; C11D 1/12; C11D 1/90

(52) U.S. Cl. CPC C11D 11/0017; C11D 1/90; C11D 1/662; C11D 1/123; C11D 1/66

(57) ABSTRACT

The present disclosure provides sulfate-free detergent formulations comprising water, a nonionic surfactant, and at least a second surfactant, wherein the formulation has a Zein score of less than about 3 percent when tested as a 10% dilution.

### BACKGROUND

Field

The present disclosure is directed to sulfate-free liquid laundry detergent formulations and methods for using the same. The formulations comprise various surfactants having low skin irritation potential.

Background

Surfactants including sulfate groups, and in particular, sodium lauryl sulfate (SLS), are commonly used, highly effective, surfactants found in many mainstream personal hygiene products including shampoos, toothpastes, mouthwashes, soaps, detergents, and body washes. Despite their utility and effectiveness, concerns have been raised about the long and short term safety profiles of products containing these surfactants. SLS in particular, has been identified as an ingredient possibly linked to health concerns.

Some reports, for example, indicate that SLS, even at low concentration, causes skin and eye irritation. Surfactants with a sulfate group such as SLS are known to be harsh on skin and have a higher Zein score than non-sulfated surfactants such as alcohol ethoxylate and alkyl polyglucosides. (Spitz, Luis. SODEOPEC: Soaps, Detergents, Oleochemicals, and Personal Care Products. Champaign, Ill.: AOC S, 2004. Print). Zein score can be measured using a Zein test (Gott, E., Aesthet. Medzin., Tenside 15: 313 (1966)), although other methodologies are known in the art. The Zein test determines the extent of denaturation of Zein corn protein after exposure to a surfactant for a given period of time. The higher the Zein score, the greater the skin irritation potential.

While the amount of irritation caused by sulfate-containing surfactants is disputed, consumer demand is shifting to products that are not only SLS-free, but sulfate-free in general. Consumer demand notwithstanding, developing sulfate-free formulations that meet consumer performance expectations has proven difficult. And sulfate-free, and in particular SLS-free products, have only slowly entered the market. Thus, there is a need for new sulfate-free detergent formulations.

### BRIEF SUMMARY

The present disclosure provides sulfate-free laundry detergent formulations comprising water, a nonionic surfactant having a Zein score of less than about 1 percent when tested as a 1% active surfactant solution; and a second surfactant having a Zein score of less than about 2.5 percent or less than about 2 percent when tested as a 1% active surfactant solution. The formulation can further have a total Zein score of less than about 3 percent when tested as a 10% dilution and can be substantially sulfate free. As discussed above, low Zein scores correlate with reduced skin and eye irritation potential. In view of the low Zein scores of the components of the present formulations and the low overall Zein score of the formulation, the formulations provide significantly reduced irritation potential versus currently marketed laundry detergents. The present formulations further have excellent detergency and stability.

The present disclosure further provides methods of manufacturing these formulations as well as methods of using these formulations. Zein score can be measured as described elsewhere herein.

In certain embodiments, this disclosure provides an aqueous detergent formulation comprising water, a nonionic surfactant; and at least a second surfactant, wherein the formulation has a Zein score of less than about 3 percent when tested as a 10% dilution, and is substantially sulfate-free.

In certain embodiments, the nonionic surfactant is an ethoxylated alcohol having a Zein score of less than about 1 percent.

In certain embodiments, the ethoxylated alcohol having a Zein score of less than about 1 percent comprises from about 5 to about 30 percent of the formulation by weight.

In certain embodiments, the ethoxylated alcohol having a Zein score of less than about 1 percent comprises from about 5 to about 20 percent of the formulation by weight.

In certain embodiments, the ethoxylated alcohol having a Zein score of less than about 1 percent comprises from about 8 to about 16 percent of the formulation by weight.

In certain embodiments, the nonionic surfactant having a Zein score of less than about 1 percent is an ethoxylated alcohol comprising one or more C₉-C₁₅ primary alkanols that has been condensed with 4 to 10 moles of ethylene oxide per mole of C₉-C₁₅ primary alkanol.

In certain embodiments, the ethoxylated alcohol is C₁₂-C₁₅ primary alkanol condensed with 7 moles of ethylene oxide per mole of primary alkanol.

In certain embodiments, the at least a second surfactant is an amphoteric surfactant having a Zein score of less than about 2 percent when tested as a 1% active surfactant solution, an anionic surfactant having a Zein score of less than about 2 percent when tested as a 1% active surfactant solution, or a second nonionic surfactant having a Zein score of less than about 2 percent when tested as a 1% active surfactant solution.

In certain embodiments, the amphoteric surfactant having a Zein score of less than about 2 percent is a betaine.

In certain embodiments, the betaine is a C₈-C₁₈ alkyl-amidoalkylbetaine having the formula

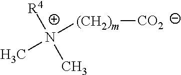

wherein R⁴ is a hydrocarbon chain containing from 8 to 18 carbon atoms, interrupted by an amide group, and m is an integer from 1 to 4.

In certain embodiments, R⁴ is R⁵—CONH—(CH₂)ₙ— and R⁵ is a linear or branched C₈-C₁₈ alkyl group and n is 2, 3, or 4.

In certain embodiments, R⁵ is a C₉-C₁₃ alkyl group.

In certain embodiments, R⁵ is a linear C₁₁ alkyl group; and n is 3.

In certain embodiments, the betaine comprises from about 1 to about 10 weight percent of the formulation.

In certain embodiments, the betaine comprises from about 1 to about 5 weight percent of the formulation.

In certain embodiments, the betaine comprises from about 1 to about 3.5 weight percent of the formulation.

In certain embodiments, the betaine comprises about 2.4 or about 3.3 weight percent of the formulation.

In certain embodiments, the betaine is cocoamidopropylbetaine.

In certain embodiments, the second nonionic surfactant having a Zein score of less than about 2 percent is a mixture of one or more alkyl polyglucosides, each alkyl polyglucoside having the formula:

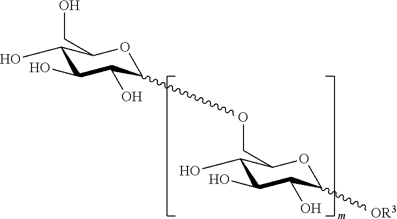

wherein for each alky polyglucoside each m is individually an integer from 1 to 10; and each R³ is individually a linear or branched C₈-C₁₈ alkyl group.

In certain embodiments, each R³ is a linear C₈-C₁₆ alkyl group.

In certain embodiments, the second nonionic surfactant having a Zein score of less than about 2 percent comprises from about 1 to about 30 weight percent of the formulation.

In certain embodiments, the second nonionic surfactant comprises from about 1 to about 20 weight percent of the formulation.

In certain embodiments, the second nonionic surfactant having a Zein score of less than about 2 percent comprises from about 1 to about 15 weight percent of the formulation.

In certain embodiments, the second nonionic surfactant having a Zein score of less than about 2 percent comprises about 10 weight percent of the formulation.

In certain embodiments, the anionic surfactant having a Zein score of less than about 2 percent is an α-sulfofatty acid ester.

In certain embodiments, the α-sulfofatty acid ester is a methyl ester sulfonate.

In certain embodiments, the methyl ester sulfonate is a C₁₆ methyl ester sulfonate, a C₁₈ methyl ester sulfonate, or a mixture thereof.

In certain embodiments, the α-sulfofatty acid ester comprises from about 0.5 to about 5 weight percent of the formulation.

In certain embodiments, the α-sulfofatty acid ester comprises from about 2 to about 3 weight percent of the formulation.

In certain embodiments, the α-sulfofatty acid ester comprises about 2 or about 2.5 weight percent of the formulation.

In certain embodiments, the formulation disclosed herein further comprises at least one component selected from the group consisting of a pH adjusting agent, one or more enzymes, a defoamer, a hydrotrope, a shading dye, a soil release polymer, an anti-redeposition polymer, a chelating agent, a preservative, an opacifier, a fragrance, and mixtures thereof.

In certain embodiments, the formulation has a cloud point of at least about 110° F.

In certain embodiments, the formulation has a cloud point of at least about 115° F.

In certain embodiments, the formulation has a cloud point of at least about 120° F.

In certain embodiments, the formulation has a cloud point of at least about 125° F.

In certain embodiments, colored fabrics washed with the formulation described herein have a mean Delta E of less than 5 after 10 wash/dry cycles.

In certain embodiments, colored fabrics washed with the formulation described herein have a mean Delta E of less than 5 after 20 wash/dry cycles.

In still other embodiments, colored fabrics washed with the formulation described herein have a mean Delta E of less than 5 after 30 wash/dry cycles.

In yet another embodiments, colored fabrics washed with the formulation described herein have a mean Delta E of from about 1 to about 5 after 10, 20, and 30 wash/dry cycles.

In certain embodiments, the present disclosure provides a method for retaining color in a washed fabric, the method comprising washing the fabric at least 10 times in an aqueous detergent formulation comprising water, a nonionic surfactant, and at least a second surfactant, wherein the formulation has a Zein score of less than about 3 percent when tested as a 10% dilution, and is substantially sulfate-free.

In certain embodiments, the fabric has a mean Delta E of less than 10 after 10 wash/dry cycles.

In certain embodiments, the fabric has a mean Delta E of less than about 5 after 10 wash/dry cycles.

In certain embodiments, the fabric has a mean Delta E of less than about 3 after 10 wash/dry cycles.

Additional embodiments and advantages of the formulations disclosed herein can be set forth in the detailed description that follows.

It can be to be understood that both the foregoing summary and the following detailed description can be exemplary and explanatory only and can be not restrictive.

### BRIEF DESCRIPTION OF THE DRAWINGS

The foregoing summary, as well as the following detailed description of the embodiments, will be better understood when read in conjunction with the appended figures. For the purpose of illustration, the figures may describe the use of specific embodiments. It should be understood, however, that the formulations described herein cannot be limited to the precise embodiments discussed or described in the figures.

FIG. 1 depicts the color stability of fabrics washed with a formulation described herein in relationship to fabrics washed in other detergents or just water.

### DETAILED DESCRIPTION

The articles “a,” “an,” and “the” can be used herein to refer to one or to more than one (i.e., to at least one) of the grammatical object of the article, unless the language and/or context clearly indicates otherwise. By way of example, “an element” means one element or more than one element.

As used herein, the terms “comprises,” “comprising,” “having,” “including,” “containing,” and the like can be open-ended terms meaning “including, but not limited to.”

As used herein, the term “about” means ±10% of the recited value. Thus, and by way of example only, the phrase “about ten” means 9 to 11.

As used herein, the phrase “substantially free” or “substantially X-free,” wherein X is a specified ingredient, means that a given formulation is at least about 97 percent by weight free of the specified ingredient, and in certain embodiments as specified herein, at least about 98, at least about 99, at least about 99.9, or at least about 99.99 percent by weight free of the specified ingredient.

As used herein, the phrase “weight percent,” “percent by weight,” and the like mean weight percent based on the quantity of active agent in a given component. For example, certain components of the formulations disclosed herein are only commercially available as X weight percent solutions in water. A formulation described herein including Y weight percent of the component that is an X weight percent aqueous solution is calculated based on the amount of active ingredient in the aqueous solution and not the weight of the total aqueous solution added to the formulation. That is, and by way of example only, a formulation weighing 100 g and including 10 weight percent of component A (the “active”), which is only commercially available as a 50 weight percent (w/w) aqueous solution, includes 10 g of component A—even though 20 g of the commercial solution was added to the formulation to reach 10 weight percent. For a pure solid, weight percent is calculated using standard techniques.

As used herein, the term “dilution” means that a formulation is diluted with water to make a diluted product. For example, “10% dilution” means a diluted product containing 10 wt % of the original formulation.

As used herein the phrase “Zein score” and “% Zein” refer to a Zein measurement obtained using the Zein test as described in the Examples. Zein scores for formulations (or detergent products) described herein refer to Zein scores obtained when a 10% dilution of a given formulation (or detergent product) is tested. Zein scores for individual surfactants refer to Zein scores obtained from testing 1% active surfactant solutions.

The present disclosure provides sulfate-free laundry detergent formulations comprising water, a nonionic surfactant, and a second surfactant. The formulation has a total Zein score of less than about 3 percent when tested as a 10% dilution and can be substantially or completely sulfate-free. As described earlier, a low Zein score correlates with reduced irritation potential. Thus, the formulations described herein are believed to be highly mild when in contact with skin, while maintaining effective detergency and acceptable stability. In certain embodiments, in vitro cytokine release test can be used to evaluate the irritation effect of a surfactant formulation by measuring cytokine release of representative human skin model in response to the surfactant formulation. Where skin tissue viability is not decreased by 50% as compared to the negative control tissue (as measured by MTT reduction), the inflammatory potential is then measured by the production of cytokines IL-1α and/or IL-1ra. A lower cytokine release value means a milder surfactant formulation.

The formulations described herein have a Zein score of less than about 3% when tested as a 10% dilution. In certain embodiments, the formulations have a Zein score of from about 0.01% to about 3%, from about 0.01% to about 2.75%, from about 0.01% to about 2.5%, from about 0.01% to about 2.25%, from about 0.01% to about 2%, from about 0.01% to about 1.75%, from about 0.01% to about 1.5%, from about 0.01% to about 1.25%, or from about 0.01% to about 1%. In other embodiments, the formulations described herein can have a Zein score of less than about 2.75%, less than about 2.5%, less than about 2.25%, less than about 2%, less than, 1.75%, less than about 1.5%, less than about 1.25%, less than about 1%, less than about 0.75%, less than about 0.5%, less than about 0.25%, or less than about 0.125%.Water is a large component of the formulation and the formulation can comprise from about 50 to about 80 weight percent of the formulation, from about 55 to about 80 weight percent of the formulation, from about 60 to about 80 weight percent of the formulation, from about 65 to about 80 weight percent of the formulation, from about 65 to about 75 weight percent of the formulation, or about 66, about 67, about 68, about 69, about 70, about 71, about 72, about 73, about 74, or about 75 weight percent of the formulation.

Nonionic Surfactant

The formulations of the present application contains one or more nonionic surfactants. In some embodiments, the nonionic surfactant can be an ethoxylated nonionic surfactant having a Zein score of less than about 1 percent when tested as a 1% active surfactant solution. In some embodiments, the ethoxylated nonionic surfactant can be an aliphatic primary alcohol ethoxylate. In some embodiments, the ethoxylated nonionic surfactant can be an aliphatic secondary alcohol ethoxylate. In some embodiments, the alcohol ethoxylates can be the condensation products of an organic aliphatic or alkyl aromatic hydrophobic compound and hydrophilic ethylene oxide groups. The length of the polymerized ethylene oxide chain can be adjusted to achieve the desired balance between the hydrophobic and hydrophilic elements.

Ethoxylated nonionic surfactants having a Zein score of less than about 1 percent include the condensation products of a higher alcohol (e.g., an alkanol containing 8 to 16 carbon atoms in a straight or branched chain configuration) condensed with 4 to 20 moles of ethylene oxide, for example, lauryl or myristyl alcohol condensed with 16 moles of ethylene oxide (EO), tridecanol condensed with 6 moles of EO, myristyl alcohol condensed with 10 moles of EO per mole of myristyl alcohol, the condensation product of EO with a cut of coconut fatty alcohol containing a mixture of fatty alcohols with alkyl chains varying from 10 to 14 carbon atoms in length and wherein the condensate contains either 6 moles of EO per mole of total alcohol or 9 moles of EO per mole of alcohol, and tallow alcohol ethoxylates containing 6 EO to 11 EO per mole of alcohol.

In some embodiments, the ethoxylated alcohol can be a higher aliphatic, primary alcohol containing 9-15 carbon atoms, such as C₉-C₁₁ alkanol condensed with 4 to 10 moles of ethylene oxide, C₁₂-C₁₃ alkanol condensed with 6.5 moles ethylene oxide (for example, NEODOL 91-8 or NEODOL 9-15 (Shell Chemicals, Netherlands)), C₁₂-C₁₅ alkanol condensed with 12 moles ethylene oxide (for example, NEODOL 25-12 (Shell Chemicals, Netherlands)), C₁₂-C₁₅ alkanol condensed with 9 moles ethylene oxide (for example, NEODOL 25-9 (Shell Chemicals, Netherlands)), C₁₄-C₁₅ alkanol condensed with 13 moles ethylene oxide (for example, NEODOL 45-13 (Shell Chemicals, Netherlands)), or a C₁₂-C₁₄ alkanol condensed with 2, 3, 4, 7, 9, or 10 moles of ethylene oxide.

In some embodiments, the ethoxylated alcohol can be a C₁₂-C₁₄ alkanol condensed with 7 moles of ethylene oxide. In some embodiments, the ethoxylated alcohol can be C₁₂-C₁₅ alkanol condensed with 7 moles of ethylene oxide. In some embodiments, the C₁₂-C₁₅ alkanol condensed with 7 moles of ethylene oxide can be NEODOL 25-7 (Shell Chemicals, Netherlands).

Ethoxylated alcohols containing 9-15 carbon atoms have an HLB (hydrophobic lipophilic balance) value of 8 to 15 and give good oil-in-water emulsification, whereas ethoxylated alcohols with HLB values below 7 contain less than 4 ethylene oxide groups and tend to be poor emulsifiers and poor detergents.

Additional satisfactory water soluble alcohol ethylene oxide condensates having the required Zein score can be the condensation products of a secondary aliphatic alcohol containing 8 to 18 carbon atoms in a straight or branched chain configuration condensed with 5 to 30 moles of ethylene oxide. Examples of commercially available nonionic detergents of the foregoing type can be C₁₂-C₁₄ secondary alkanol condensed with either 9 EO (TERGITOL™ 15-S-9 (Dow Chemical Company, Michigan, United States)) or 12 EO (TERGITOL™ 15-S-12 (Dow Chemical Company, Michigan, United States)).

In still other embodiments, the nonionic surfactant having a Zein score of less than about 1 percent can be a methyl ester ethoxylate having the formula RC(═O)(OCH₂CH₂)ₓOCH₃ where R is an alkyl chain having from 12 to 18 carbon atoms and x is 6, 7, 8, 9, 10, 11, 12, 13, 14, or 15. In certain embodiments, R is an alkyl chain having from 12 to 14 carbon atoms and x is 15. In still other embodiments, R is an alkyl chain having 18 carbon atoms and x is 15. These surfactants are available from LION CORPORATION.

In some embodiments, nonionic surfactant having a Zein score of less than about 1 is an ethoxylated alcohol. In particular embodiments, the composition comprises an effective amount of the ethoxylated alcohol. In other embodiments, the formulation comprises by weight from about 1% to about 30%, from about 1% to about 25%, from about 1% to about 24%, from about 1% to about 23%, from about 1% to about 22%, from about 1% to about 21%, from about 1% to about 20%, from about 5% to about 20%, from about 5% to about 19%, from about 5% to about 18%, from about 5% to about 17%, from about 5% to about 16%, from about 8% to about 16%, or about 8%, about 16%, or about 15.5% of the ethoxylated alcohol. In some embodiments, the ethoxylated alcohol is C₁₂-C₁₅ alkanol condensed with 7 moles of ethylene oxide (NEODOL 25-7) and the ethoxylated alcohol is present in any of the ranges specified above.

In addition to the nonionic surfactant having a Zein score of less than about 1 percent, the present formulations further include a second surfactant. In some embodiments the second surfactant is an amphoteric surfactant having a Zein score of less than about 2.5 percent or less than about 2 percent when tested as a 1% active surfactant solution, an anionic surfactant having a Zein score of less than about 2.5 percent or less than about 2 percent when tested as a 1% active surfactant solution, a second nonionic surfactant having a Zein score of less than about 2 percent when tested as a 1% active surfactant solution, or a combination of any of the foregoing.

Anionic Surfactant

In some embodiments, the second surfactant can be an anionic surfactant having a Zein score of less than about 2.5 percent or less than about 2 percent when tested as a 1% active surfactant solution. In some embodiments, the anionic surfactant can be an alkylene sulfofatty acid salt (also referred to herein as an α-sulfofatty acid ester), such as a methylester sulfonate (“MES”) of a fatty acid (e.g., palm oil-based MES). Such a sulfofatty acid can be formed by esterifying a carboxylic acid with an alkanol and then sulfonating the α-position of the resulting ester.

In typical embodiments, the α-sulfofatty acid ester can be a salt having formula (I):

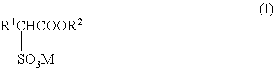

wherein R¹ and R² can be alkanes and M can be a monovalent metal. For example, R¹ can be an alkane containing 4 to 24 carbon atoms, and in particular embodiments, can be a C₈, C₁₀, C₁₂, C₁₄, C₁₆, and/or C₁₈ linear alkane. R² can be an alkane containing 1 to 8 carbon atoms, and in certain embodiments, a methyl or ethyl group. M can be an alkali metal, such as sodium or potassium. The α-sulfofatty acid ester of formula (I) can be a sodium methyl ester sulfonate, such as a sodium C₈-C₁₈ methyl ester sulfonate.

In certain embodiments, the α-sulfofatty acid ester can be a C₁₀, C₁₂, C₁₄, C₁₆, or C₁₈ α-sulfofatty acid ester. In one embodiment, R¹ can be a linear C₁₀ alkane, R² can be methyl, and M can be sodium (sodium methyl-2-sulfolaurate).

In another embodiment, the α-sulfofatty acid ester comprises a mixture of sulfofatty acids. For example, the composition can comprise a mixture of α-sulfofatty acid esters, such as C₁₀, C₁₂, C₁₄, C₁₆, and C₁₈ sulfofatty acids. The proportions of different chain lengths in the mixture can be selected according to the properties of the α-sulfofatty acid esters. For example, C₁₆ and C₁₈ sulfofatty acids (e.g., from tallow and/or palm stearin MES) generally provide better surface active agent properties, but can be less soluble in aqueous solutions. C₁₀, C₁₂, and C₁₄ α-sulfofatty acid esters (e.g., from palm kernel oil or coconut oil) can be more soluble in water, but have lesser surface active agent properties. Suitable mixtures include C₈, C₁₀, C₁₂, and/or C₁₄ α-sulfofatty acid esters with C₁₆ and/or C₁₈ α-sulfofatty acid esters. For example, about 1 to about 99 weight percent of C₈, C₁₀, C₁₂, and/or C₁₄ α-sulfofatty acid ester can be combined with about 99 to about 1 weight percent of C₁₆ and/or C₁₈ α-sulfofatty acid ester. In another embodiment, the mixture can comprise about 1 to about 99 weight percent of a C₁₆ or C₁₈ α-sulfofatty acid ester and about 99 to about 1 weight percent of a C₁₆ or C₁₈ α-sulfofatty acid ester. In yet another embodiment, the α-sulfofatty acid ester can be a mixture of C₁₈ methyl ester sulfonate and a C₁₆ methyl ester sulfonate and having a ratio of about 2:1 to about 1:3.

Methods of preparing α-sulfofatty acid esters can be known to the skilled artisan. (See, e.g., U.S. Pat. Nos. 5,587,500; 5,384,422; 5,382,677; 5,329,030; 4,816,188; and 4,671,900; the disclosures of which are incorporated herein by reference.) α-Sulfofatty acid esters can be prepared from a variety of sources, including beef tallow, palm kernel oil, palm kernel (olein) oil, palm kernel (stearin) oil, coconut oil, soybean oil, canola oil, cohune oil, coco butter, palm oil, white grease, cottonseed oil, corn oil, rape seed oil, soybean oil, yellow grease, mixtures thereof, or fractions thereof. Other sources of fatty acids to make α-sulfofatty acid esters include caprylic (C₈), capric (C₁₀), lauric (C12), myristic (C₁₄), myristoleic (C₁₄), palmitic (C₁₆), palmitoleic (C₁₆), stearic (C₁₈), oleic (C₁₈), linoleic (C₁₈), linolenic (C₁₈), ricinoleic (C₁₈), arachidic (C₂₀), gadolic (C₂₀), behenic (C₂₂), and erucic (C₂₂) fatty acids. α-Sulfofatty acid esters prepared from one or more of these sources are within the scope of the present invention.

When included in the formulation described herein, the formulations disclosed herein comprise an effective amount of α-sulfofatty acid ester (i.e., an amount which exhibits the desired cleaning and surfactant properties). In other embodiments, the formulation can comprise least about 0.5 weight percent α-sulfofatty acid ester. In another embodiment, the formulation can comprise at least about 1 weight percent α-sulfofatty acid ester or at least about 2 weight percent α-sulfofatty acid ester. In some embodiments, the weight percent of the α-sulfofatty acid ester can range from about 0.5% to about 10%, from about 0.5% to about 5%, from about 0.5% to about 4.5%, from about 0.5% to about 4%, from about 0.5% to about 3.5%, from about 0.5% to about 3%, from about 0.5% to about 2.5%, or from about 0.5% to about 2%. In particular embodiments, the formulation can comprise about 2% or about 2.5% α-sulfofatty acid ester. In some embodiments, the formulation comprises about 2% by weight or about 2.5% by weight of α-sulfofatty acid ester comprising a mixture of a C₁₆ methyl ester sulfonate and a C₁₈ methyl ester sulfonate.

Exemplary anionic surfactants having a Zein score of less than about 2.5 percent include, but are not limited to: sodium C14-16 olefin sulfonate (BIO-TERGE AS-40, Stepan Company); potassium oleate sulfonate (POLYSTEP OPA, Stepan); sodium C12-15 pareth-15-sulfonate (AVANEL S 150 CGN, BASF); sodium methyl cocoyl taurate (Pureact WS Conc., Innospec); disodium laureth sulfosuccinate (STEPAN-MILD SL3-BA, Stepan); sodium lauryl sulfoacetate and disodium laureth sulfosuccinate (STEPAN-MILD LSB, Stepan); sodium cocoyl isethionate, sodium lauroyl methyl isethionate (ISELUX LQ-CLR, Innospec); disodium laureth sulfosuccinate (MACANATE ELK, Solvay) and sodium laureth-5-carboxylate, derived from neutralization of laureth-6-carboxylic acid (EMPICOL CED 5, Huntsman). Additional examples of alkyl ether carboxylates include capryleth-6-carboxylic acid (AKYPO LF1, KAO CORPORATION), also capryleth-9-carboxylic acid (AKYPO LF2) and a mixture of capryleth-9-carboxylic acid with hexeth-4-carboxylic acid (AKYPO LF4). Additional examples from HUNTSMAN CORPORATION include sodium laureth-4-carboxylate (EMPICOL CBC S), sodium laureth-5-carboxylate (purchased as EMPICOL CED 5 S) or derived from laureth-5-carboxylic acid (EMPICOL CED 5) and sodium laureth-11-carboxylate, derived from laureth-11-carboxylic acid (EMPICOL CBJ).

In certain embodiments, the formulation can comprise, by weight, about 1% to about 10%, about 1% to about 9%, about 1% to about 8%, about 2% to about 7%, about 2% to about 6%, about 3% to about 6%, about 4% to about 6%, or about 5% of these other anionic surfactants.

In some embodiments, the formulation can be substantially or completely anionic surfactant free.

Amphoteric Surfactant

In certain embodiments, the formulation comprises, by weight, about 1% to about 10%, about 1% to about 9%, about 1% to about 8%, about 1% to about 7%, about 1% to about 6%, about 1% to about 5%, about 1% to about 4%, about 1% to about 3.5%, about 2% to about 3.5%, or about 2.4% or about 3.3% of the amphoteric surfactant having a Zein score of less than about 2.5 percent or less than about 2 percent when tested as a 1% active surfactant solution. In other embodiments, the formulation can be substantially or completely amphoteric surfactant free.

In particular, embodiments, the amphoteric surfactant having a Zein score of less than about 2.5 percent can be a betaine having the general structure:

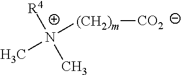

wherein R⁴ is a hydrocarbon chain containing from 8 to 18 carbon atoms, interrupted by an amide group, and m is an integer from 1 to 4. In certain embodiments, R⁴ is R⁵—CONH—(CH₂)ₙ— wherein R⁵ is a linear or branched C₈-C₁₈ alkyl group and n is 2, 3, or 4. In some embodiments, R⁵ is a linear C₈-C₁₈ alkyl group and n is 2, 3, or 4. In some embodiments, R⁵ is a linear C_{H} alkyl group and n is 3 (cocoamidopropyl betaine (“CAPB”)). In certain embodiments, the formulation can comprise about 1% to about 10%, about 1% to about 9%, about 1% to about 8%, about 1% to about 7%, about 1% to about 6%, about 1% to about 5%, about 1% to about 4%, about 1% to about 3.5%, about 2% to about 4%, or about 2.4% or about 3.3% CAPB.

Other amphoteric surfactants with Zein scores less than about 2.5 percent include the chemical classes such as amphoacetates, amphopropionates, aminopropionate, and ampho sulfonate. Examples include sodium lauroamphoacetate (MIRANOL Ultra L32, SOLVAY), sodium lauriminodipropionate (MIRATAINE H2C-HA, SOLVAY).

In one embodiment, the present disclosure provides a formulation containing from about 8% to about 16% of alcohol ethoxylate 7EO and, optionally, up to about 3.3% of CAPB by weight. In some embodiments, the formulation of the present disclosure can contain about 16% of alcohol ethoxylate 7EO and about 3.3% of CAPB by weight.

Second Nonionic Surfactant

The second nonionic surfactant having a Zein score of less than about 2 percent when tested as a 1% active surfactant solution, when present, can comprise, by weight, from about 0.05% to about 30% of the formulation, from about 0.05% to about 25%, from about 0.05% to about 20%, from about 0.05% to about 19%, from about 0.05% to about 18%, from about 0.05% to about 17%, from about 0.05% to about 16%, from about 0.05% to about 15%, from about 0.05% to about 14%, from about 0.5% to about 15%, from about 0.5% to about 14%, from about 0.5% to about 13%, or from about 0.5% to about 12.5% of the formulation. In other embodiments, the second nonionic surfactant can comprise, by weight, from about 2.5% to about 12.5% of the formulation, or about 5% or about 10% of the formulation.

In certain embodiments, the second nonionic surfactant can be an ethoxylated nonionic surfactant described above. In certain embodiments, the second nonionic surfactant having a Zein score of less than about 2 percent can be an alkyl polyglucoside, or a mixture of alkyl polyglucosides, each having the formula:

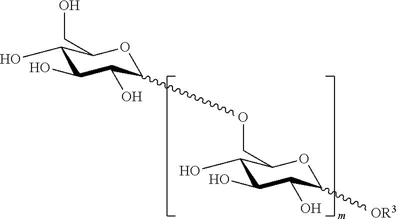

wherein m is an integer from 1 to 10 and R³ is a linear or branched C₈-C₁₈ alkyl group. Alkyl polyglucosides and methods for preparing them are well known in the art and are discussed, generally, in WO 1997/026315, U.S. Pat. No. 7,077,870, U.S. Pat. No. 3,598,865, U.S. Pat. No. 4,565,647, EP 132043, and EP 132046, each of which is incorporated by reference in its entirety.

In particular embodiments, the alkyl polylglucoside can be an aqueous mixture of alkyl polyglucosides, such as a GLUCOPON, specific examples of which include GLUCOPON 420 UP (CAS 110615-47-9 and 68515-73-1), GLUCOPON 425 N (CAS 110615-47-9 and 68515-73-1) (sold in some markets as GLUCOPON 425 N/HH), GLUCOPON 600 UP (CAS 110615-47-9) (sold in some markets as GLUCOPON 600 CSUP), and GLUCOPON 650 EC (CAS 110615-47-9 and 68515-73-1), all available from BASF. In a particular embodiment, the formulation comprises about 10% by weight of GLUCOPON 600 UP. In another embodiment, the formulation comprises about 10% by weight of GLUCOPON 425 N.

In some embodiments, the second nonionic surfactant having a Zein score of less than about 2 percent can be an amine oxide such as lauramine oxide.

In some embondiments, the second nonionic surfactant can be a block co-polymer of ethylene oxide and propylene oxide. Examples include the PLURONIC series from BASF, such as Pluronic 25R4, 22R4, 17R4 and Pluronic P84, P85, P75, L62, L63, L64, L44 and P65.

Formulations Comprising a Third Surfactant

In certain embodiments, in addition to containing a nonionic surfactant and a second surfactant, a given formulation can also contain a third surfactant. The third surfactant can be an amphoteric surfactant, an anionic surfactant, or a nonionic surfactant as discussed above.

In one embodiment, a given formulation of the present disclosure can comprise a nonionic surfactant, an anionic surfactant, and an amphoteric surfactant.

In certain embodiments, the formulation of the present disclosure can contain from about 8% to about 16% of a nonionic surfactant, from about 1% to about 8% of an anionic surfactant, and up to about 3.3% of an amphoteric surfactant.

Thus, in some embodiments, a given formulation of the present disclosure can contain from about 8% to about 16% of alcohol ethoxylate 7EO, from about 1% to about 8% of alkyl ether carboxylate, and up to about 3.3% of CAPB by weight.

Other Components

In addition to the components noted above, the formulations described herein can also contain one or more ingredients conventionally included in fabric treatment formulations such as pH buffering or adjusting agents, builders, metal chelating agents, enzymes, anti-redeposition polymers, soil-release polymers, perfumes, fluorescent agents, shading dyes, colorants, hydrotropes, antifoaming agents, polyelectrolytes, optical brightening agents, pearlescers, anti-shrinking agents, anti-wrinkle agents, anti-spotting agents, germicides, fungicides, anti-corrosion agents, drape imparting agents, anti-static agents, ironing aids, crystal growth inhibitors, anti-oxidants, and anti-reducing agents. Examples and sources of suitable such components are well-known in the art and/or are described herein.

For example, in some embodiments, the formulation can comprise glycerin (glycerol) as a hydrotrope. In some embodiments, the formulation comprises from about 1% to about 25%, from about 1% to about 20%, from about 1% to about 15%, from about 1% to about 10%, from about 1% to about 5%, or from about 1% to about 2.5% glycerin by weight. In some embodiments, the formulation can comprise about 50% or about 2.5% glycerin by weight. In other embodiments, however, the formulation can be completely or substantially glycerin free.

The formulations described herein can further include one or more pH adjusting agents. Suitable pH adjusting agents are known to those of ordinary skill in the art but include acids such as hydrochloric acid and bases such as sodium hydroxide, citric acid, triethanolamine, and monoethanolamine. For example, in certain embodiments, the present formulations can include an appropriate amount of one or more pH adjusting agents such that the pH of the formulation ranges from about 7 to about 8.5. In particular embodiments, the pH can range from about 7 to about 8, from about 7 to about 7.75, from about 7 to about 7.5, or from about 7 to about 7.25. In other embodiments, the pH can be about 7, about 7.25, about 7.5, about 7.75, about 8, about 8.25, or about 8.5. The formula can also be buffered using sodium carbonate, providing a pH range of about 10.4 to 11.2.

In certain embodiments, the formulations described herein can include more than one pH adjusting agent, with each pH adjusting agent present at from about 0.1% to about 5% by weight. In other embodiments, each pH adjusting agent can be present from about 0.1% to about 4% by weight, from about 0.1% to about 3% by weight, from about 0.1% to about 2% by weight or from about 0.1% to about 1% by weight.

In certain embodiments, the formulation can comprise at least one of citric acid, sodium hydroxide, and triethanolamine. In certain embodiments, the formulation can include citric acid, triethanolamine, and sodium hydroxide.

In certain embodiments, the citric acid can be present at from about 1% to about 5% by weight, and in particular embodiments, at about 1.25% by weight or at about 2.5% by weight. In other embodiments, however, the formulation can be completely or substantially citric acid free.

In certain embodiments, the triethanolamine can be present from about 0.5% by weight to about 1.25% by weight. In certain embodiments, the triethanolamine can be present from about 0.75% by weight to about 1% by weight. And in still further embodiments, the triethanolamine can be present at about 0.85% by weight. In other embodiments, however, the formulations can be completely or substantially triethanolamine free.

Sodium hydroxide, when present, can be added in an amount sufficient to achieve the desired pH. But in certain embodiments, the amount of sodium hydroxide in the formulation can range from about 0.5% by weight to about 2% by weight. In still other embodiments, the amount of sodium hydroxide can range from about 0.7% by weight to about 1.5% by weight. In still other embodiments, the amount of sodium hydroxide present in the formulation can be about 0.5 to about 0.8% by weight or about 1% by weight to about 2% by weight.

In certain embodiments, the formulation can also comprise a metal chelating agent. Suitable metal chelating agents include polycarboxylic acids such as methyl glycinediacetic acid (MGDA), succinic acid, iminodisuccinic acid (IDS), trisodium ethylenediamine disuccinate (EDDS), pentasodium diethylenetriamine pentatacetate. (DTPA), carboxymethylated polyethyleneimine (trade name Trilon P from BASF), ethylenediaminetetrasaceticacid (EDTA), salts of any of the foregoing, and mixture of any of the foregoing. Other suitable chelating agents include those sold by Dow under the VERSENEX trade name, by BASF under the TRILON trade name, and by Akzo Nobel under the DISSOLVINE trade name.

In certain embodiments, the chelating agent can be present from about 0.01% by weight to about 4.0% by weight. In other embodiments, the chelating agent can be present from about 0.1% to about 2% by weight, or from about 0.2% by weight to about 1% by weight, In other embodiments, the chelating agent can be present at about 0.25% by weight. In one embodiment, the chelating agent can be iminodisuccinic acid.

In certain embodiments, the formulations can also include one or more biocidal agents such as triclosan (5-chloro-2 (2,4-dichloro-phenoxy) phenol), and the like.

In further embodiments, the formulations described herein can also include one or more optical brighteners such as TINOPAL® AMS (a stillbene), TINOPAL 5BM-GX (stilbene disulfonic acid derivative), TINOPAL® CBS-X (a distyrylbiphenyl derivative), and/or a stilbene/naphthotriazole blend such as TINOPAL® RA-16, all sold by BASF. In some embodiments, the optical brightener can be present from about 0.01% to about 0.5% by weight, from about 0.01% to about 0.4% by weight, from about 0.1% to about 0.3% by weight, from about 0.15% to about 0.25% by weight, or about 0.2% or about 0.1% by weight.

The formulations described herein can further include an enzyme. Suitable enzymes include those known in the art, such as amylolytic, proteolytic, cellulolytic, or lipolytic type, and those listed in U.S. Pat. No. 5,958,864, the disclosure of which is incorporated herein by reference in its entirety. One suitable protease, sold under the trade name SAVINASE® by Novo Nordisk Industries A/S, is a subtillase from Bacillus lentus. Other suitable enzymes include proteases, amylases, lipases and cellulases, such as ALCALASE® (bacterial protease), EVERLASE® (protein-engineered variant of SAVINASE®), ESPERASE® (bacterial protease), LIPOLASE® (fungal lipase), LIPOLASE ULTRA (protein-engineered variant of LIPOLASE), LIPOPRIME® (protein-engineered variant of LIPOLASE), TERMAMYL® (bacterial amylase), BAN (Bacterial Amylase Novo), CELLUZYME® (fungal enzyme), and CISZYME® (monocomponent cellulase), sold by Novo Nordisk Industries A/S. In some embodiments, the enzyme can be stabilized CORONASE® or CORONASE® with 0.75 4-formyl phenyl boronic acid (4-FPBA) available from Novozymes A/S (Copenhagen, Denmark). Also suitable for use in the formulations of the present invention can be blends of two or more of these enzymes which can be produced by many of these manufacturers, for example a protease/lipase blend, a protease/amylase blend, a protease/amylase/lipase blend, and the like. In some embodiments, the enzyme can be an amylase such as STAINZYME® from Novozymes A/S (Copenhagen, Denmark). In some embodiments, the enzyme can be an amylase such as PREFERENZ™ from DuPont (Wilmington, Del.). In some embodiments, the formulations can include a mannan stain remover such as MANNAWAY® (Novozymes, Copenhagen, Denmark).

The enzyme can be added in any appropriate amount suitable to achieve its intended purpose. But in certain embodiments, the enzyme can be present from about 0.5% to about 1.5% by weight of the formulation, and in certain embodiments at about 0.75% by weight of the formulation.

The formulation disclosed herein can also include a defoamer. In certain embodiments, the defoamer can be a salt of coconut oil fatty acid (also referred to as coconut fatty acid or dodecanoic acid). In particular embodiments, the defoamer is the sodium salt of coconut oil fatty acid. In some embodiments, the salt of coconut oil fatty acid can be present from about 0.1% to about 5% by weight of the formulation, from about 0.1% to about 4% by weight of the formulation, from about 0.1% to about 3% by weight of the formulation, from about 0.1% to about 2.5% by weight of the formulation, from about 0.1% to about 2% by weight of the formulation, from about 0.1% to about 1.5% by weight of the formulation, from about 0.1% to about 1% by weight of the formulation. In other embodiments, the coconut oil fatty acid can be present at about 1% by weight of the formulation.

In other embodiments, the defoamer can be an organosiloxane-type defoamer, such as any of the defoaming agents disclosed and described in U.S. Patent Application Publication No. 2013/0326823, U.S. Patent Application Publication No. 2013/0327364, U.S. Patent Application Publication No. 2014/0023609, and U.S. Patent Application Publication No. 2014/0352076, each of which is incorporated herein by reference in its entirety.

In some embodiments, the formulation can comprise at least one anti-redeposition agent. In some embodiments, the anti-redeposition agent can be an anti-redeposition polymer. In some embodiments, the anti-redeposition agent can be an acrylic acid polymer, an acrylic acid/maleic acid copolymer, an acrylic acid/methacrylic acid copolymer, or a carboxylate polyelectrolyte copolymer. In some embodiment, the anti-redeposition agent can be an acrylic polymer selected from SOKALAN PA 30, SOKALAN PA 20, SOKALAN PA 15, and SOKALAN CP 10 (BASF GmbH, Germany) and ACUSOL 445G and ACUSOL 445N (The Dow Chemical Company, Midland, Mich.). In some embodiments, the anti-redeposition agent can be an acrylic acid/maleic acid copolymer selected from ACUSOL 460N and ACUSOL 505N (The Dow Chemical Company, Midland, Mich.) and SOKALAN CP 5, SOKALAN CP 45, and SOKALAN CP 7 (BASF GmbH, Germany). In some embodiments, the anti-redeposition agent can be an acrylic/methacrylic copolymer. In some embodiments, the anti-redeposition agent can be an anionic polymer selected from ALCOSPERSE 725 and ALCOSPERSE 747 (Alco Chemical, Chattanooga, Tenn.) and ACUSOL 480N (The Dow Chemical Company, Midland, Mich.). In some embodiments, the anti-redeposition agent can be ACUSOL 445G (The Dow Chemical Company, Midland, Mich.). In some embodiments, the anti-redeposition agent can be ACUSOL 445N (The Dow Chemical Company, Midland, Mich.). In some embodiments, the anti-redeposition agent can be ALCOSPERSE 747. In some embodiments, the anti-redeposition agent can be DEQUEST SPE 1202 (Italmatch Chemicals, Genova, Italy). In some embodiments, the anti-redeposition polymer can be SOKALAN HP 20 (BASF, Germany) an ethoxylated polyethylene imine.

In some embodiments, the anti-redeposition agent can be an acrylic homopolymer having an average molecular weight between 3,000 and 6,000. In some embodiments, the anti-redeposition agent can be an acrylic homopolymer having an average molecular weight of about 4,500.

In some embodiments, the anti-redeposition agent can be an acrylic/styrene copolymer having an average molecular weight between 1,500 and 6,000. In some embodiments, the anti-redeposition agent can be an acrylic/styrene copolymer having an average molecular weight of about 3,000.

In some embodiments, the formulation can comprise from about 0.01% to about 5%, from about 0.01% to about 2.5%, from about 0.01% to about 1%, from about 0.01% to about 0.5%, from about 0.1% to about 0.4%, from about 0.1% to about 0.3%, or from about 0.15% to about 0.3% by weight of the anti-redeposition agent. In other embodiments, the formulation can comprise about 0.25% by weight of the anti-redeposition agent.

The formulations described herein can further include one or more shading dyes. Suitable shading dyes can include chromophore types including, but not limited to, azo, anthraquinone, triarylmethane, methine quinophthalone, azine, oxazine, and thiazine, which may be of any desired color, hue, or shade. Suitable shading dyes can be obtained from many major suppliers such as Clariant, Dystar, Avecia, BASF, Milliken, and Bayer. In some embodiments, the shading dye can be LIQUITINT blue HP dye. In some embodiments, the shading dye can be disperse violet 28 (DV28). In other embodiments, however, the formulations disclosed herein can be completely or substantially shading dye-free.

The formulations disclosed herein can optionally include one or more perfumes or fragrances. As used herein, the term “perfume” can be used in its ordinary sense to refer to, and include, any fragrant substance or mixture of substances including natural (obtained by extraction of flowers, herbs, leaves, roots, barks, wood, blossoms, or plants), artificial (mixture of natural oils or oil constituents), and synthetically produced odoriferous substances. Typically, perfumes can be complex mixtures of blends of various organic compounds such as alcohols, aldehydes, ethers, aromatic compounds and varying amounts of essential oils (e.g., terpenes) such as from 0% to 80%, usually from 1% to 70% by weight, of the essential oils themselves—being volatile odoriferous compounds and also serving to dissolve the other components of the perfume. Suitable perfume ingredients include those disclosed in “Perfume and Flavour Chemicals (Aroma Chemicals)”, published by Steffen Arctander (1969), which can be incorporated herein by reference. In some embodiments, the perfume can be lavender. To the extent a perfume is included in a given formulation, from about 0.01% to about 5% by weight of the perfume can be included. In certain embodiments, about 0.75 weight percent perfume can be included in the formulation. In other embodiments, however, the formulation can be completely or substantially free of perfumes.

In other embodiments, the formulations can include one or more soil-releasing polymers. Suitable soil-releasing polymers include, but are not limited to, TEXCARE SRN—a nonionic polyester of polypropylene terephthalate (Clariant); REPEL-O-TEX SRP—a polyethylene glycol polyester (Solvay); end-capped and non-end-capped sulfonated and unsulfonated PET/POET polymers of the type disclosed in WO 2010/069957 and WO 1995/032997; polyethylene glycol/polyvinyl alcohol graft copolymers such as SOKALAN HP 22 (BASF, Germany); and anionic hydrophobic polysaccharides of the type disclosed in U.S. Pat. No. 6,764,992. Each of the patent publications noted in this paragraph are incorporated herein by reference in their entirety.

In some embodiments, the formulations comprise a bittering agent such as denatonium benzoate, sold under the trade name of BITREX® (Johnson Matthey, London, United Kingdom).

In some embodiments, the formulations can include up to about 3 weight percent of the soil-releasing polymer. In other embodiments, the formulation can include up to about 2 weight percent of the soil-releasing polymer. And in still further embodiments, the formulation can include about 1% by weight of the soil-releasing polymer.

The formulations herein may further include one or more preservatives, such as ROCIMA 586 (a mixture of 5-Chloro-2-methyl-4-isothiazolin-3-one (CMIT), 2-Methyl-4-isothiazolin-3-one (MIT), and 2-Bromo-2-nitropropane-1,3-diol (bronopol) sold by The Dow Chemical Company, Midland, Mich.) and/or ACTICIDE CBM2 (a mixture of 5-Chloro-2-methyl-4-isothiazolin-3-one, 2-Methyl-4-isothiazolin-3-one, and 1,2-Benzisothiazolin-3-one, manufactured by THOR GmbH, Speyer, Germany.

Stability and Cleaning Capabilities

Cloud point is the temperature above which an aqueous solution of a water-soluble surfactant becomes turbid. The cloud point is an important factor for determining storage stability. Storing formulations at temperatures significantly higher than the cloud point can result in phase separation and instability.

In addition to having significantly reduced irritation potential, certain embodiments of the formulations described herein also have surprisingly excellent stability. That is, certain formulations can withstand high and low temperatures for an extended period of time without any effect on the formulations.

More specifically, and surprisingly, the formulations disclosed herein can, in certain embodiments, have a sufficiently high cloud point to permit the formulation to be transported in various climates without being concerned that the product will phase separate at higher temperatures. In some embodiments, the formulation disclosed herein can have a cloud point of at least about 100° F. In other embodiments, the formulations disclosed herein can have a cloud point of at least about 110° F., at least about 115° F., at least about 120° F., at least about 125° F., at least about 130° F., at least about 135° F., at least about 140° F., at least about 145° F., or at least about 150° F. In certain embodiments, the formulations disclosed herein can have a cloud point of at least about 125° F.

In certain embodiments, the formulations disclosed herein can undergo a series of freeze/thaw cycles without adverse effects on the formulation. For example, in certain embodiments, the formulation can undergo three storage cycles at 0° F. for 8 to 12 hours, with each freeze cycle followed by recovery at room temperature for 8 to 24 hours. Under this protocol, the formulation does not develop any non-dissolvable precipitates or phase separate.

In still further embodiments, the formulations disclosed herein can have both the cloud point specified herein and be stable after multiple freeze/thaw cycles.

The present formulations also promote color retention in fabrics. For example, the formulations disclosed herein produce fabrics having a low mean Delta E, even after multiple washes, all as compared to a given fabric's original color. Delta E is defined as the difference between two colors in an L*a*b* color space. Delta E is also called Delta E*, ΔE*, DE*, or dE*. Delta E is often used to determine the change in color of an colored article when it is washed.

For example, in some embodiments, the formulations disclosed herein provide fabrics having a mean Delta E of less than 10 after 10 wash/dry cycles, less than 10 after 20 wash/dry cycles, and less than 10 after 30 wash/dry cycles. In other embodiments, the formulations disclosed herein provide fabrics having a mean Delta E of less than 7 after 10 wash/dry cycles, less than 7 after 20 wash/dry cycles, and less than 8 after 30 wash/dry cycles. In other embodiments, the formulations disclosed herein provide fabrics having a mean Delta E of from about 1 to about 7 after 10 wash/dry cycles, from about 1 to about 7 after 20 wash/dry cycles, and from about 1 to about 7 after 30 wash/dry cycles. In still other embodiments, the formulations disclosed herein provide fabrics having a mean Delta E of from about 1 to about 5 after 10 wash/dry cycles, from about 1 to about 5 after 20 wash/dry cycles, and from about 1 to about 5 after 30 wash/dry cycles. For each of the embodiments noted above, Delta E is measured according to CIELAB.

### EXAMPLES

The formulations described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1

### General Zein Score Procedure

The “test surfactant solution” can be a solution with 1 wt % active surfactant when a surfactant is tested by itself Alternatively, the test surfactant solution can be a 10 wt % dilution of a formulation or product described herein. As an example: 5 grams of a detergent formula, such as Formula 1 described below, was accurately weighed and diluted with 45 grams of deionized water to bring the total solution weight to 50 grams. An aliquot (3.0 mL) was accurately measured and removed and set aside in a closed container as a blank solution. To the remaining about 47 mL of solution, was added approximately 2 g Zein protein (purchased from SPECTRUM CHEMICAL). If all of the Zein protein was dissolved, 1 gram of additional Zein protein was added so that some solid remained undissolved. The mixture was stirred for one hour at room temperature. Undissolved Zein was then removed by filtration to obtain a filtrate solution. A 3.0 ml aliquot of the filtrate solution was accurately measured and placed in a tared aluminum pan and dried in an oven at 70° C. The percent of solids was calculated. Likewise, the blank solution was dried at 70° C. and the solids content of this 3 mL aliquot was determined. The solid weight in the blank solution was subtracted from the solid weight in the filtration solution and the quantity of dissolved Zein in the filtration solution was calculated by difference and reported as g Zein/100 g surfactant solution (also called “% Zein” or “Zein score”).

### Example 2

### Surfactant Zein Scores

The Zein scores of several surfactants were measured according to the procedure described in Example 1 using 1 wt % active surfactant solutions. The results are set forth in Table 1.

TABLE 1

| | % Zein |
|---|---|
| Surfactant | (g/100 g surfactant solution) |
| Sodium lauryl sulfate (SLS) | 2.70 |
| Methyl ester sulfonate C16-C18 (MES) | 1.55 |
| Cocoamidopropyl betaine (CAPB) | 0.56 |
| NEODOL 25-7 | 0.17 |
| Alkyl polyglucoside (APG) | 0.00 |

Table 1 shows that MES, CAPB, NEODOL 25-7, and APG all solubilize significantly less Zein than SLS.

### Example 3

### Sample Formulations

The samples described in Table 2 were prepared in a glass beaker using an overhead mixer with light to moderate agitation (200-500 rpm). Ingredients were added to the vessel beginning with water and following the order listed in Table 2. Special care was taken with regards to the pH of the formulation with any necessary adjustments made by adding NaOH (50% active aqueous solution) as needed to a pH of 7.4 to 8.0 prior to the addition of preservatives, enzymes, and fragrance.

TABLE 2

| | Formula 1 | Formula 2 | Formula 3 | Formula 4 | Formula 5 |
|---|---|---|---|---|---|
| | 2.4% | 3.3% | 2.0% | 2.5% | 10% |
| Ingredient | CAPB | CAPB | MES | MES | APG |
| Water (Deionized) | q/s | q/s | q/s | q/s | q/s |
| Citric Acid | 1.25 | 1.25 | 1.25 | 1.25 | 2.5 |
| Triethanolamine | 0.85 | 0.85 | 0.85 | 0.85 | 0.8 |
| Sodium Hydroxide | 0.7 | 0.75 | 0.6 | 0.7 | 1.5 |
| Coconut Fatty Acid | 1.0 | 1.0 | 1.0 | 1.0 | 1.0 |
| Alcohol Ethoxylate 7EO | 15.6 | 16.0 | 16.0 | 15.5 | 8.0 |
| Cocoamidopropyl Betaine (CAPB) | 2.4 | 3.3 | — | — | — |
| Methyl Ester Sulfonate (MES) | — | — | 2.0 | 2.5 | — |
| Alkylpolyglucoside (APG) | — | — | — | — | 10.0 |
| Glycerine | 2.5 | 5.0 | 2.5 | 5.0 | — |
| Optical Brightener | 0.21 | 0.21 | 0.21 | 0.21 | 0.12 |
| Soil Release Polymer | 1.0 | 1.0 | 1.0 | 1.0 | 1.0 |
| Anti-redeposition Polymer | 0.25 | 0.25 | 0.25 | 0.25 | 0.25 |
| Iminodisuccinic Acid | 0.25 | 0.25 | 0.25 | 0.25 | 0.25 |
| Preservative 1 | — | 0.01 | — | 0.01 | — |
| Preservative 2 | 0.03 | — | 0.03 | — | 0.03 |
| Enzyme | 0.75 | 0.75 | 0.75 | 0.75 | 0.75 |
| Opacifier | — | 0.1 | — | 0.1 | 0.1 |
| Fragrance | 0-0.75 | 0-0.75 | 0-0.75 | 0-0.75 | 0-0.75 |

*all components above listed as % by weight

### Example 4

### Comparative In Vitro Cytokine Release Study 1

The EPIDERM Skin Model by MatTek Corporation, a validated in vitro model for effectively predicting in vivo skin irritation for a wide range of components, including surfactants, was used for this study. The MatTek protocol relies on normal, human-derived, epidermal keratinocytes (NHEK) which have been cultured to form a multilayered, highly differentiated model of the human epidermis (the “MatTek tissue culture”). The MatTek tissue culture acts as a stand-in for actual human skin.

According to the protocol, an aliquot of 100 μl of a 1% aqueous dilution by weight of Formula 5 or the Commercial Comparator was applied to the surface of a MatTek tissue culture and was allowed to remain on the tissue culture surface for 1 hour. Each of Formula 5 and the Commercial Comparator were tested in triplicate. After exposure, the tissue cultures were individually rinsed five times with 0.5 ml calcium and magnesium free phosphate buffered saline (PBS) solution. The rinses were then discarded. Each tissue was then placed in a designated well in a new 6-well plate containing 0.9 ml of fresh hydrocortisone free assay medium. The tissues were then incubated at standard culture conditions for approximately 24 hours.

Following incubation, the 6-well plates were gently agitated to evenly mix any cytokine released into the medium. The tissues were then removed from the incubation medium, blotted dry (not rinsed), and transferred to a 24-well plate containing 300 μl of a 1.0 mg/ml MTT solution comprising PBS and MTT Addition Medium. The tissues were then incubated at standard culture conditions for 3±0.1 hours. Following incubation, the medium under each tissue was removed and frozen for later cytokine analysis (IL-1α and/or IL-1ra). Once thawed, cytokine production (IL-1α and/or IL-1ra) was measured using a standard ELISA assay. Results within each group were then averaged to provide the results noted below.

Comparison of Formula 5 with a premium gentle commercially available laundry detergent (“Commercial Comparator”) comprising water, sodium alcohol ethoxy sulfate, propylene glycol, borax, ethanol, linear alkylbenzene sulfonate sodium salt, polyethyleneimine ethoxylate, diethylene glycol, trans sulfated & ethoxylated hexamethylene diamine, alcohol ethoxylate, linear alkylbenzene sulfonate, MEA salt, sodium formate, sodium alkyl sulfate, DTPA, amine oxide, calcium formate, disodium diaminostilbene disulfonate, amylase, protease, dimethicone, and benzisothiazolinone, shows that the formulations disclosed herein causes less cytokine release than the Commercial Comparator, and are thus very mild.

TABLE 3

| | Average IL-1α |
|---|---|
| Product | Cytokine (pg/mL) |
| Formula 5 | 55 |
| Commercial | 79 |
| Comparator | |

### Example 5

### Comparative In Vitro Cytokine Release Study 2

Using the general protocol described in Example 4, MatTek tissue cultures were treated for 1 hour with a 3% aqueous dilution by weight of one of Formulas 2, 4, or the Commercial Comparator (3 replicates per formula). As in Example 4, individual results in a given group of replicates were averaged to provide an overall response.

Table 4 shows that the sulfate free detergent formulas including CAPB and MES are significantly milder than the Commercial Comparator.

TABLE 4

| | Average | Average IL- |
|---|---|---|
| | IL-1α | 1ra |
| | Cytokine | Cytokine |
| Product | (pg/mL) | (pg/mL) |
| Formula 4 | 187 | 11977 |
| Formula 2 | 157 | 9997 |
| Commercial | 697 | 21777 |
| Comparator | | |

### Example 6

### Comparative Cleaning Performance

The cleaning performance of Formulas 2 and 4 were evaluated versus the Commercial Comparator used in Example 4 across two white fabrics (woven cotton/polyester blend and knitted cotton) at two temperatures (59 and 90° F.) in 120 ppm hard water (3:1 ratio of Ca²⁻ to Mg²⁻). Identical fabrics stained with four different Non-Food Stains and four different Food Stains were prepared for each of Formulas 2, 4, and the Commercial Comparator and then washed and dried.

Delta E* was then calculated for each stain on each fabric against unstained unwashed white fabrics using the standard CIELab color difference equation which provides that Delta E* equals the square root of the sums of squares of the differences in the L*, a*, and b* color coordinates for the washed stained portion of the fabric and the unstained unwashed white fabric. An average Delta E* for food stains and non-food stains for each test wash for each of Formulas 2, 4, and the Commercial Comparator was then calculated. Average residual stain index (“RSI”) was then calculated by subtracting the Average Delta E* from 100. Finally, average Delta RSI was calculated by individually subtracting the RSI for formulas 2 and 4 from the RSI for the Commercial Comparator. Results are shown in Table 5.

TABLE 5

| Test Formulation: | Stain/Temperature (° F.) | Average Delta RSI |
|---|---|---|
| Formula 2 | Non-food Stains/90 | −0.57 |
| | Non-food Stains/59 | −0.77 |
| | Food Stains/90 | −0.36 |
| | Food Stains/59 | −0.37 |
| Formula 4 | Non-food Stains/90 | −0.20 |
| | Non-food Stains/59 | −0.12 |
| | Food Stains/90 | −0.39 |
| | Food Stains/59 | 0.54 |

The data in Table 5 shows that the inventive formulas do not have an average Delta RSI of greater than two units—the average Delta RSI visible to consumers—indicating that the formulas described herein provide comparable cleaning performance to a leading commercial sulfate-containing detergent formula.

### Example 7

### Additional Cleaning Performance

To test whether greater stain removal could be obtained, five additional formulas based on Formula 2 were prepared by adding 5 weight percent of an anionic surfactant. Thus the surfactant blend contains alcohol ethoxylate 7EO (16%), CAPB (3.3%) and an additional surfactant (5%). Stain removal data is shown as average Delta RSI (calculated as in Example 6) for 4 stains and 2 fabrics of test formula relative to a premium sulfate-containing surfactant composition (3.5% LAS, 9% AES, 12.6% alcohol ethoxylate 7EO).

TABLE 6

| Additional Surfactant (5%) | | | |
|---|---|---|---|
| added to Formula 2 | Stain Set | Temp (° F.) | Delta RSI |
| Sodium C14-16 olefin | Non-food | 90 | 0.11 |
| sulfonate (BIO-TERGE AS- | Non-food | 59 | 0.06 |
| 40, Stepan) | Food | 90 | 0.06 |
| | Food | 59 | −0.27 |
| Sodium lauroyl methyl | Non-food | 90 | 0.25 |
| isethionate (ISELUX LQ- | Non-food | 59 | −0.47 |
| CLR, Innospec) | Food | 90 | 0.22 |
| | Food | 59 | −0.14 |
| Disodium laureth | Non-food | 90 | 0.39 |
| sulfosuccinate (MACANATE | Non-food | 59 | −0.33 |
| ELK, Solvay) | Food | 90 | 0.02 |
| | Food | 59 | −0.31 |
| Methyl ester sulfonate (MES, | Non-food | 90 | 0.15 |
| Sun Products) | Non-food | 59 | −0.39 |
| | Food | 90 | 0.03 |
| | Food | 59 | −0.37 |
| CAPB | Non-food | 90 | −0.09 |
| | Non-food | 59 | −0.71 |
| | Food | 90 | −0.24 |
| | Food | 59 | −0.56 |

The formulas containing additional anionic surfactant have excellent performance compared to the premium sulfate-containing formula.

### Example 8

### Fabric Color Retention

Three fabrics with colors known to fade with washing (reactive orange 16, reactive red 141, and reactive black 5) were washed with Formula 2 and were compared to a mid-tier unit dose product (neutral pH) and water only. Washing was conducted in 90° F. in 120 ppm hard water (3:1 ratio of Ca²⁺ to Mg²⁺) wash liquor both with and without 1 ppm chlorine. The fabrics were tumble dried after each wash.

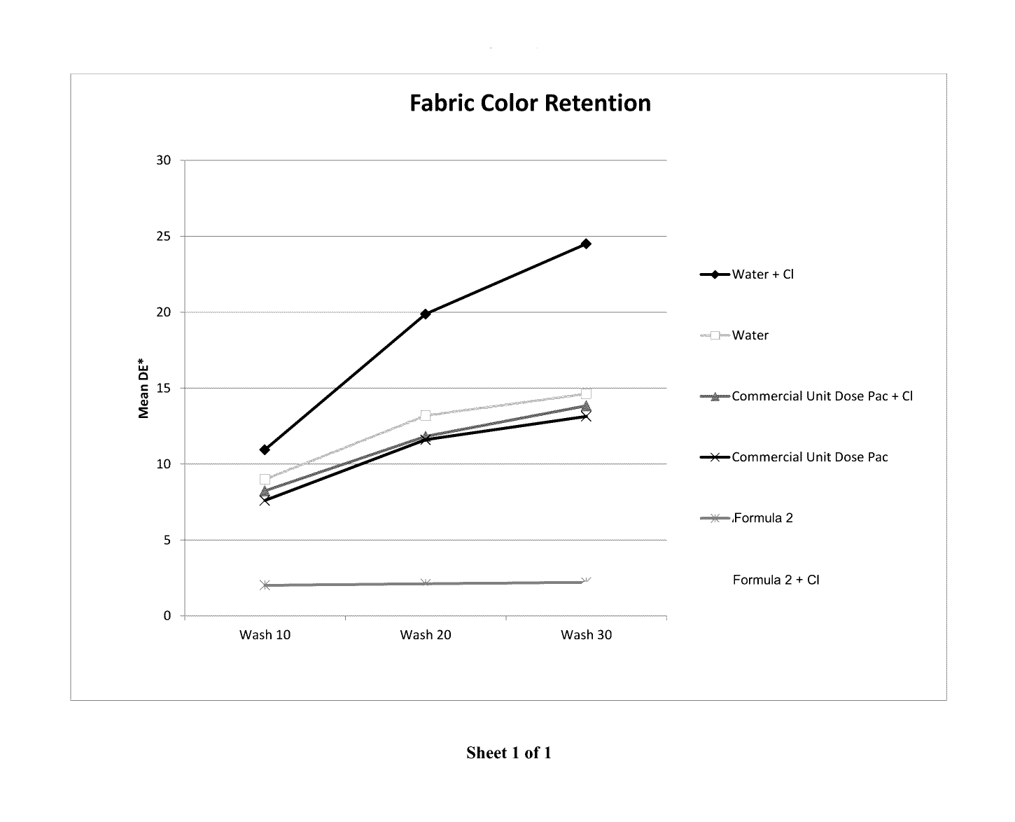

FIG. 1, with data points at 10, 20, and 30 wash cycles, shows that washing with Formula 2 results in significantly less fading (“DE*” or “Delta E*”) than washing with either the unit dose product and even results in less fading than washing in water alone, regardless of whether chlorine is present. Delta E* was calculated using CIELab as in Example 6.

### Example 9

### Zein Score for Exemplary Formulations

The Zein scores for exemplary formulas 1 and 3 described in Example 3 were measured using the procedure described in Example 1 using 10% dilutions. As a control, a Zein score was also measured for the Commercial Comparator using a 10% dilution. The results, shown in Table 7, indicate that the formulations described herein are unlikely to cause irritation and are in fact, more gentle than the Commercial Comparator which is marketed as being gentle to skin.

TABLE 7

| Formula | % Zein (g/100 g formula) |
|---|---|
| Formula 1 | 0.6 |
| Formula 3 | 1.1 |
| Commercial Comparator | 3.9 |

### Example 10

### Stability Study

While mildness is a key component of the formulations described herein, not all mild formulas were found to be stable when stored at 125° F. for 1 week. For example, a formula comprising 13.5% alcohol ethoxylate 7EO and 4.5% APG (GLUCAPON 600) resulted in a phase separation into two liquid phases at 125° F. Similarly, a formula comprising only alcohol ethoxylate 7EO (18%) showed the same instability. It was discovered that addition of certain anionic or zwitterionic surfactants could increase the cloud point temperature and thus provide good high temperature storage stability.

Twelve commercially available mild surfactants were added to a base formulation containing alcohol ethoxylate—7EO, APG (GLUCAPON 600), and citric acid, to screen the stability of the resultant formulations. All of the commercial surfactants are milder than SLS as determined by literature Zein scores (Table 8). The resultant formulations contained 3 weight percent of the mild surfactant, 13 weight percent alcohol ethoxylate—7EO, 2 weight percent APG (GLUCAPON 600), and 1.5 weight percent citric acid. Stability data is reported in Table 8.

A balance must be achieved between formula stability and formula mildness. Using too high a level of certain anionic surfactants can result in harsh formulas, which is undesirable. For example, Formula 15, which uses the anionic surfactant AOS, is a harsher formula due to the high Zein score of this ingredient (75%) compared to Formula 13 which uses CAPB with a Zein score of 30%. A balance was found between adding just enough of the proper anionic or zwitterionic surfactant to keep the formula stable at high temperature, and not adding too much to cause a decrease in the mildness of the formulation.

TABLE 8

| | Surfactant | | Normalized | |
|---|---|---|---|---|
| | Trade Name | Surfactant Chemical | Zein Score of | |
| Formula | (Vendor) | Name | Surfactant* | Stable at 125° F.? |
| 6 | AVANEL S 150 | Sodium C12-15 | | yes |
| | CGN (BASF) | Pareth-15-Sulfonate | | |
| 7 | EMPICOL CED 5 | Laureth-6 Carboxylic | | yes |
| | (HUNTSMAN) | Acid | | |
| 8 | ISELUX LQ-CLR | Sodium Lauroyl | | yes |
| | (INNOSPEC) | Methyl Isethionate | | |
| 9 | POLYSTEP OPA | Potassium Oleate | | yes |
| | (STEPAN) | Sulfonate | | |
| 10 | Pureact WS Conc. | Sodium Methyl | 45 | yes |
| | (INNOSPEC) | Cocoyl Taurate | | |
| 11 | STEPAN-MILD | Disodium Laureth | 44 | yes |
| | SL3-BA | Sulfosuccinate | | |
| | (STEPAN) | | | |
| 12 | STEPAN-MILD | Sodium Lauryl | 25 | yes |
| | LSB (STEPAN) | Sulfoacetate & | | |
| | | Disodium Laureth | | |
| | | Sulfosuccinate | | |
| 13 | AMPHOSOL CA | Cocamidopropyl | 30 | yes |
| | (STEPAN) | betaine | | |
| 14 | MES | Sodium methyl 2- | 68 | yes |
| | | sulfolaurate | | |
| 15 | BIO-TERGE AS- | Sodium C14-16 Olefin | 75 | yes |
| | 40 (STEPAN) | Sulfonate (AOS) | | |
| 16 | Crodasinic L30 | Sodium Lauryl | | No, precipitate |
| | (CRODA) | Sarcosinate | | |
| 17 | GLUCOPON 600 | | | No, phase separation |

*Zein scores are normalized to SLS as 100%; Data from Stepan Chemical company literature.

### Example 11

### Additional Exemplary Formulations

Additional examples of the formulations of the present disclosure can be prepared according to the surfactant ratios shown in Table 9.

TABLE 9

| | Formula | | Formula | Formula |
|---|---|---|---|---|
| Surfactants | 18 | Formula 19 | 20 | 21 |
| Alcohol ethoxylate 7EO | 8 | 13 | | 11 |
| Alcohol ethyoxylate 9EO | 4 | | 15 | |
| CAPB | 3 | 3 | 3 | 2 |
| Laureth-5-carboxylic acid | 3 | | | 5 |
| sodium cocoyl isethionate | | 3 | | |

Having now fully described this invention, it will be understood by those of ordinary skill in the art that the same can be performed within a wide and equivalent range of conditions, formulations and other parameters without affecting the scope of the invention or any embodiment thereof.

Other embodiments of the invention will be apparent to those skilled in the art from consideration of the specification and practice of the invention disclosed herein. It is intended that the specification and examples be considered as exemplary only, with a true scope and spirit of the invention being indicated by the following claim.

1. An aqueous detergent formulation comprising:
a) water
b) a nonionic surfactant; and
c) at least a second surfactant;
wherein the formulation
has a Zein score of less than about 3 percent when tested as a 10% dilution; and is substantially sulfate-free.

2. The formulation of claim 1, wherein the nonionic surfactant is an ethoxylated alcohol having a Zein score of less than about 1 percent when tested as a 1% active surfactant solution.

3. The formulation of claim 2, wherein the ethoxylated alcohol having a Zein score of less than about 1 percent comprises from about 5 to about 30 percent of the formulation by weight.

4. (canceled)

5. (canceled)

6. The formulation of claim 1, wherein the nonionic surfactant is an ethoxylated alcohol having a Zein score of less than about 1 percent when tested as a 1% active surfactant solution and comprising one or more C₉-C₁₅ primary alkanols that has been condensed with 4 to 10 moles of ethylene oxide per mole of C₉-C₁₅ primary alkanol.

7. (canceled)

8. The formulation of claim 1, wherein the at least a second surfactant is an amphoteric surfactant having a Zein score of less than about 2 percent when tested as a 1% active surfactant solution, an anionic surfactant having a Zein score of less than about 2 percent when tested as a 1% active surfactant solution, or a second nonionic surfactant having a Zein score of less than about 2 percent when tested as a 1% active surfactant solution.

9. The formulation of claim 8, wherein the amphoteric surfactant having a Zein score of less than about 2 percent is a betaine.

10. The formulation of claim 9, wherein the betaine is a C₈-C₁₈ alkyl-amidoalkylbetaine having the formula. 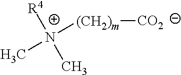
wherein R⁴ is a hydrocarbon chain containing from 8 to 18 carbon atoms, interrupted by an amide group, and m is an integer from 1 to 4.

11. The formulation of claim 10, wherein R⁴ is R⁵—CONH—(CH₂)ₙ— and R⁵ is a linear or branched C₉-C₁₃ alkyl group and n is 2, 3, or 4.

12. (canceled)

13. (canceled)

14. (canceled)

15. (canceled)

16. (canceled)

17. (canceled)

18. The formulation of claim 9, wherein the betaine is cocoamidopropylbetaine.

19. The formulation of claim 8, wherein the second nonionic surfactant having a Zein score of less than about 2 percent is a mixture of one or more alkyl polyglucosides, each alkyl polyglucoside having the formula: 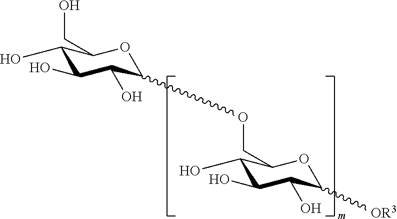
wherein for each alky polyglucoside
each m is individually an integer from 1 to 10; and
each R³ is individually a linear or branched C₈-C₁₈ alkyl group.

20. (canceled)

21. The formulation of claim 8, wherein the second nonionic surfactant having a Zein score of less than about 2 percent comprises from about 1 to about 30 weight percent of the formulation.

22. (canceled)

23. (canceled)

24. (canceled)

25. The formulation of claim 8, wherein the anionic surfactant having a Zein score of less than about 2 percent is an α-sulfofatty acid ester.

26. The formulation of claim 25, wherein the α-sulfofatty acid ester is a methyl ester sulfonate.

27. The formulation of claim 26, wherein the methyl ester sulfonate is a C₁₆ methyl ester sulfonate, a C₁₈ methyl ester sulfonate, or a mixture thereof.

28. The formulation of claim 25, wherein the α-sulfofatty acid ester comprises from about 0.5 to about 5 weight percent of the formulation.

29. (canceled)

30. (canceled)

31. The formulation of claim 1, further comprising at least one component selected from the group consisting of a pH adjusting agent, one or more enzymes, a defoamer, a hydrotrope, a shading dye, a soil release polymer, an anti-redeposition polymer, a chelating agent, a preservative, an opacifier, a fragrance, and mixtures thereof.

32. The formulation of claim 1, wherein the formulation has a cloud point of at least about 110° F.

33. (canceled)

34. (canceled)

35. (canceled)

36. The formulation of claim 1, wherein colored fabrics washed with the formulation have a mean Delta E of less than 5 after 10 wash/dry cycles.

37. (canceled)

38. (canceled)

39. (canceled)

40. A method for retaining color in a washed fabric, the method comprising washing the fabric in an aqueous detergent formulation comprising:
water
a nonionic surfactant; and
at least a second surfactant;
wherein the formulation has a Zein score of less than about 3 percent when tested as a 10% dilution; and is substantially sulfate-free.

41. The method of claim 40, wherein said fabric has a mean Delta E of less than 10 after 10 wash/dry cycles.

42. (canceled)

43. (canceled)
